(19) United States
(12) Patent Application Publication
(10) Pub. No.: US 2014/0082308 A1
(43) Pub. Date: Mar. 20, 2014

(54) STORAGE CONTROL DEVICE AND METHOD FOR CONTROLLING STORAGE DEVICES

(71) Applicant: FUJITSU LIMITED, Kawasaki (JP)

(72) Inventors: Meiu NARUSE, Yokohama (JP); Reisuke Nakagawa, Inagi (JP); Kenji Higuchi, Kawasaki (JP); Hiroyuki Shimoi, Kawasaki (JP); Hitomi Akiyama, Kawasaki (JP); Hiroshi Koarashi, Takaoka (JP)

(73) Assignee: FUJITSU LIMITED, Kawasaki (JP)

(21) Appl. No.: 13/954,387

(22) Filed: Jul. 30, 2013

(30) Foreign Application Priority Data
Sep. 20, 2012 (JP) 2012-207184

(51) Int. Cl. G06F 3/06

(52) U.S. Cl. CPC G06F 3/0653; G06F 3/061; G06F 3/0689
USPC 711/158

(57) ABSTRACT

According to an aspect of the present invention, provided is a storage control device including a processor. The processor monitors a load value of a first storage device or a second storage device during copy processing in which a copy of data stored in the first storage device is stored in the second storage device. The processor controls, in a case where the load value exceeds a predetermined threshold, the first storage device and the second storage device so that input/output processing to/from the second storage device is executed with priority over the copy processing.

### CROSS-REFERENCE TO RELATED APPLICATION

This application is based upon and claims the benefit of priority from the prior Japanese Patent Application No. 2012-207184 filed on Sep. 20, 2012, the entire contents of which are incorporated herein by reference.

### FIELD

The embodiments discussed herein are related to a storage control device and a method for controlling a storage.

### BACKGROUND

There are techniques for a storage system in which, upon completion of logical copying, storage devices (for example, disks) as a copy source and a copy destination are permitted to perform input and output (I/O) operations such as reading data (Read) and writing data (Write) while copying is actually being performed between the disks. As examples of such techniques, for example, advanced copy techniques such as One-Point Copy (OPC) and Quick OPC are known.

In such a technique, sometimes the copy load is adjusted in order to reduce the I/O load of the copy source storage device in the case where the I/O load has become high during the copying.

Japanese Laid-open Patent Publication No. 9-325863 discloses a related technique.

However, in the case where I/O for the copy destination storage device occurs, the copy load is not adjusted, with some exceptions. Specifically, at the copy source, copy control (management of a queue for copying) is performed in a controller module (CM) or redundant arrays of inexpensive disks (RAID). However, at the copy destination, only the I/O load for the copying is adjusted when the copying is delayed. Consequently, if I/O that is unrelated to the copying occurs, the I/O performance of the copy destination storage device may be reduced.

With respect to a copy source storage device, generally, a high load due to normal work and copy work is anticipated and the storage device is designed while taking into consideration the performance of a hard disk drive (HDD), a RAID or the like. However, with respect to a copy destination storage device, placing importance on capacity, it is often the case a low-speed high-capacity disk is used and therefore the copy time is long and I/O frequently occurs after logical copying is completed (in reality, physical copying is still being performed).

As an example of the delay in copy destination I/O is a case in which mount processing from Microsoft (Registered Trademark) Windows (Registered Trademark) is delayed and the server (host) performing I/O freezes. In this case, copy processing is delayed and I/O performance of the copy source storage device is also reduced.

### SUMMARY

According to an aspect of the present invention, provided is a storage control device including a processor. The processor monitors a load value of a first storage device or a second storage device during copy processing in which a copy of data stored in the first storage device is stored in the second storage device. The processor controls, in a case where the load value exceeds a predetermined threshold, the first storage device and the second storage device so that input/output processing to/from the second storage device is executed with priority over the copy processing.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a hardware configuration of an information processing system including a storage system in an embodiment;

FIG. 2 illustrates functional configurations of CMs in an embodiment;

FIG. 3 illustrates an example of connection between CMs and disks in an embodiment;

FIG. 4 illustrates an example of connection between CMs and disks in an embodiment;

FIG. 5 illustrates operations of CMs in an embodiment;

FIGS. 6A to 6F illustrate I/O patterns for a copy destination storage device during copy processing in an embodiment;

FIG. 7 illustrates state transitions of a CM in an embodiment; and

FIG. 8 is a flowchart illustrating state transitions of a CM in an embodiment.

### DESCRIPTION OF EMBODIMENT

Hereafter, an embodiment of a storage control device and a method of controlling a storage will be described with reference to the drawings. The embodiment described hereafter is simply an illustrative example and is not intended to exclude various modifications and technological applications not described therein. That is, the embodiment may be modified in various ways within the gist thereof (combining the embodiment with modifications or the like.).

Configuration

First, a configuration of a storage system of the embodiment will be described.

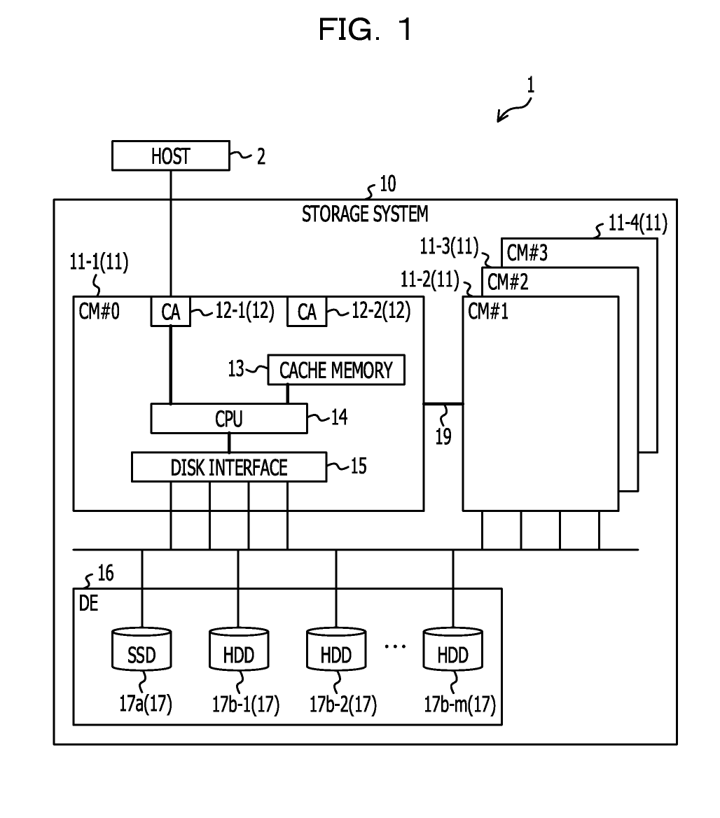

FIG. 1 illustrates a hardware configuration of an information processing system 1 including a storage system 10 of the embodiment. The information processing system 1 includes a host 2 and the storage system 10, and the host 2 and the storage system 10 are connected to each other.

The host 2 is an information processing device that performs I/O operations such as Read and Write operations of reading and writing data from and to the storage system 10, which will be described below. The storage system 10 includes a plurality (four in the example illustrated in FIG. 1) of storage control devices (CMs) 11-1 to 11-4 and a drive enclosure (DE) 16. The CMs 11-1 to 11-4 will also be referred to as CM#0 to CM#3.

Hereafter, as symbols denoting the CMs, symbols “11-1” to “11-4” will be appropriately used to specify a certain CM among the plurality of CMs and the symbol “11” will be used to indicate an arbitrary CM. Here, the CM 11-1 includes two channel adaptors (CAs) 12-1 and 12-2, a cache memory 13, a central processing unit (CPU) 14 and a disk interface (DI) 15.

The CAs 12-1 and 12-2 are modules for connecting the host 2 and the CM 11-1 to each other. The CAs 12-1 and 12-2 connect the host 2 and the CM 11-1 to each other using any of various communication standards such as fibre channel (FC), Internet Small Computer System Interface (iSCSI), serial attached Small Computer System Interface (SAS), fibre channel over ethernet (Registered Trademark) (FCoE) and infiniband.

Hereafter, as symbols denoting the CAs, symbols “12-1” and “12-2” will be appropriately used when to specify a certain CA among the plurality of CAs and the symbol “12” will be used to indicate an arbitrary CA. The cache memory 13 is a semiconductor memory. The cache memory 13 is mainly used in I/O processing in the CM 11-1 but is also used in system control. For example, the cache memory 13 is used in order to temporarily store data in performance of Read and Write from and to storage devices 17a and 17b-1 to 17b-m (m is an integer greater than or equal to 2), which will be described below.

The CPU 14 is a processing device that performs various control and arithmetic operations to be carried out by the CM 11-1. The CPU 14 reads out a program or the like stored in a read-only memory (ROM) or the like, which is not illustrated, and executes various processing operations. For example, a known CPU may be used as the CPU 14. The DI 15 is an interface such as an expander or an I/O controller (IOC) that connects the DE 16, which will be described below, and the CM 11-1 to each other using for example a Serial Attached Small Computer System Interface (SAS). The DI 15 controls the data transfer from and to the storage devices 17a, 17b-1 to 17b-m, which will be described below, inside the DE 16.

Constituent elements of the CM 11-1 such as the CAs 12-1 and 12-2, the cache memory 13, the CPU 14, and the DE 16 are connected to each other via Peripheral Component Interconnect Express (PCIe). In addition, switches, which are not illustrated, may be provided between the elements. The CMs 11-2 to 11-4 have similar configuration to the CM 11-1 and therefore illustration and description of thereof have been omitted.

The DE 16 includes a solid state disk (SSD) 17a and HDDs 17b-1 to 17b-m. Hereafter, as symbols denoting the HDDs, symbols “17b-1” to “17b-m” will be appropriately used when to specify a certain HDD among the plurality of HDDs and the symbol “17b” will be used to indicate an arbitrary HDD.

In addition, hereafter, the SSD 17a and the HDDs 17b will be collectively referred to as storage devices 17. For example, a total of 12 to 24 storage devices 17 may be mounted in the DE 16. The CMs 11-1 to 11-4 are connected to each other via an inter-CM connection 19 such as SAS or PCIe. In the case where there are three or more CMs 11, switches may be provided between the CMs 11. Next, a functional configuration of each CM 11 will be described.

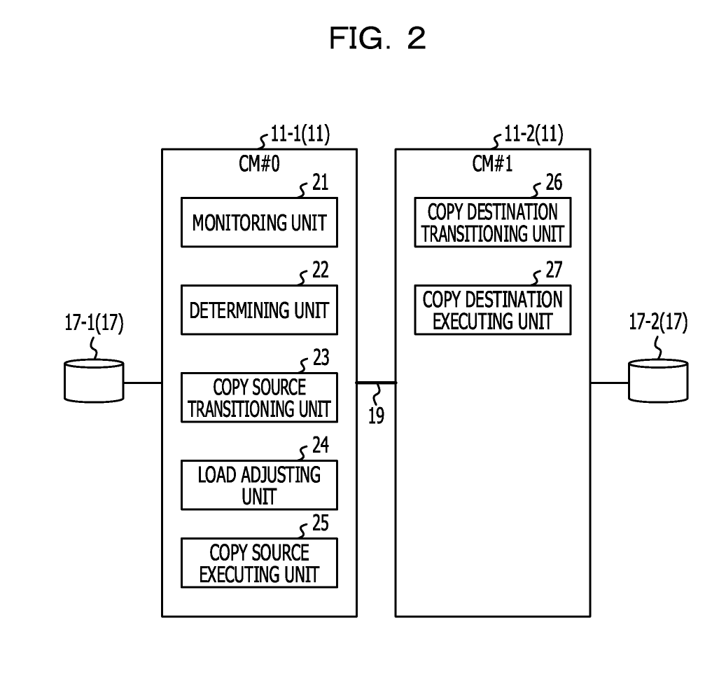

FIG. 2 illustrates functional configurations of the CMs 11 in the embodiment. In FIG. 2, copying of data between the storage devices 17 is performed by using an advanced copy technique such as OPC or Quick OPC and I/O processing to and from the storage devices 17 is possible even while physical copying is being performed. In FIG. 2 and the following description, the storage device 17-1 on the left-hand side is taken to be a disk that is a source of data to be copied and hereafter will be referred to as a copy source storage device or simply a copy source. In addition, the CM 11-1 that manages this copy source storage device 17-1 will be referred to as a copy source CM.

The storage device 17-2 on the right-hand side is taken to be a disk that is the destination of data to be copied and hereafter will be referred to as a copy destination storage device or simply a copy destination. In addition, the CM 11-2 that manages this copy destination storage device 17-2 will be referred to as a copy destination CM. In addition, the term “copy processing” refers to processing in which a copy of data stored in the copy source storage device 17-1 is stored in the copy destination storage device 17-2.

The copy source CM 11-1 includes a monitoring unit 21, a determining unit 22, a copy source transitioning unit 23, a load adjusting unit 24 and a copy source executing unit 25. The monitoring unit 21 continuously monitors load values of the copy source storage device 17-1 and the copy destination storage device 17-2. In this example, the monitoring unit 21 monitors, as the load values, amount (host I/O response time) of the host I/O load and the disk usage percentage (busy percentage) for each of the copy source storage device 17-1 and the copy destination storage device 17-2.

The host I/O response times and the disk busy percentages may be obtained by using known methods and description thereof will be omitted. The monitoring unit 21 may instead monitor the load values of at least either of the copy source storage device 17-1 and the copy destination storage device 17-2. For example, the monitoring unit 21 may monitor the load values of the copy source storage device 17-1 or the copy destination storage device 17-2. The determining unit 22 compares each load value and a predetermined threshold thereof and determines whether to cause the modes of the CMs 11 to transition. The threshold is for example set at the time of shipping of the storage system 10 from the factory, but may instead be appropriately set at a later time by the user.

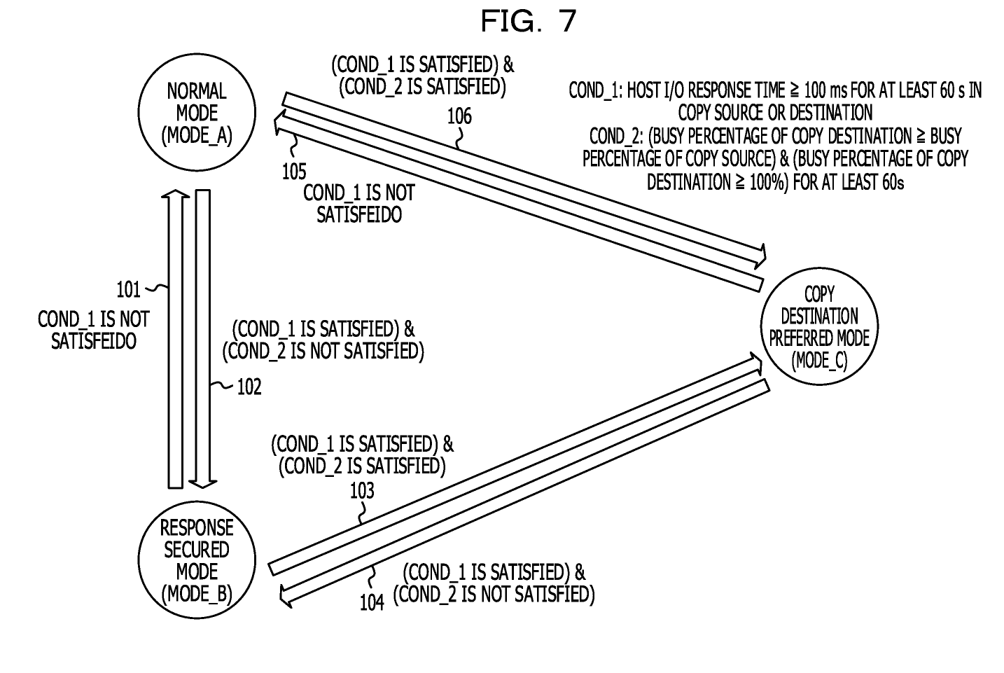

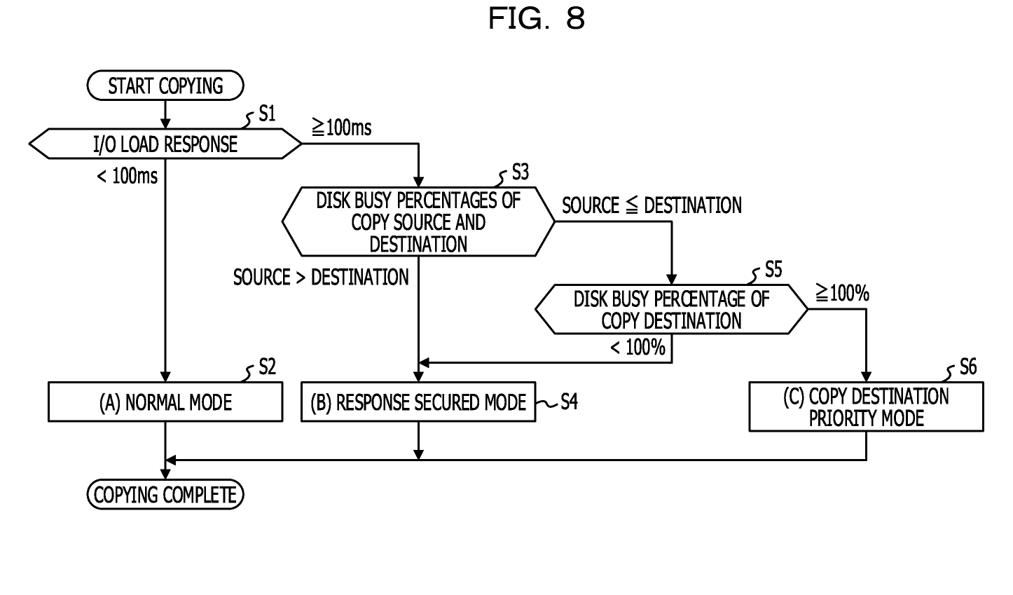

In the case where the determining unit 22 determines that the modes of the CMs 11 are to be caused to transition, the copy source transitioning unit 23 causes the mode of the copy source CM 11-1 to transition and instructs a copy destination transitioning unit 26 of the copy destination CM 11-2 to perform mode transitioning. Description will be given below of the modes and transitioning between the modes with reference to FIGS. 7 and 8. The load adjusting unit 24 adjusts the copy speed at the time of copying from the copy source storage device 17-1 to the copy destination storage device 17-2.

For example, the load adjusting unit 24 adjusts the copy speed by using two parameters of the number (multiplicity) of issued copy commands and the interval between issuing of the copy commands. In this case, the load adjusting unit 24 adjusts the number of issued copy commands in for example the range of 1 to 256 and adjusts the interval between issuing of copy commands in the range of 0 to 1000 ms (for example, 1 μs, 10 μs, 1 ms, 10 ms or 100 ms).

When increasing the copy speed, for example, the load adjusting unit 24 increases the number of issued copy commands (for example, sets it to 8). Thus, the copy processing between the copy source storage device 17-1 and the copy destination storage device 17-2 is executed with a multiplicity of 8. In addition, the load adjusting unit 24 shortens the interval between issuing of copy commands (for example, sets it to 0 s). As a result of such setting, once one copy processing operation has finished, the next copy processing operation is immediately executed with a multiplicity of 8 and the copy speed is increased.

In contrast, in the case when the copy speed is to be decreased, the load adjusting unit 24 reduces the number of issued copy commands (for example, sets it to 1). Thus, the copy processing between the copy source storage device 17-1 and the copy destination storage device 17-2 is executed with a multiplicity of 1. In addition, the load adjusting unit 24 reduces the frequency of issuing (for example, sets it to 100 ms). As a result of such setting, after one copy processing operation has finished, there is an interval of 100 ms before the next copy processing operation is executed with a multiplicity of 1 and the copy speed is decreased.

The copy source executing unit 25 executes processing to be carried out in execution of copying in the copy source storage device 17-1. For example, the copy source executing unit 25 reads out data from the copy source storage device 17-1, transfers the data to the cache memory 13, and transfers the data to a copy destination executing unit 27. In addition, the copy source executing unit 25, as will be described later, changes the priority of processing at the time of copying in accordance with the mode of the copy source CM 11-1.

The copy destination CM 11-2 includes the copy destination transitioning unit 26 and the copy destination executing unit 27. Upon being notified of a mode transition by the copy source transitioning unit 23, the copy destination transitioning unit 26 causes the mode of the copy destination CM 11-2 to transition to the instructed mode. The copy destination executing unit 27 executes processing to be carried out in execution of copying in the copy destination storage device 17-2. For example, the copy destination executing unit 27 receives data from the copy source executing unit 25, transfers the data to the cache memory 13 and writes the data into the copy destination storage device 17-2. In addition, the copy destination executing unit 27, as will be described later, changes the priority of processing at the time of copying in accordance with the mode of the copy destination CM 11-2.

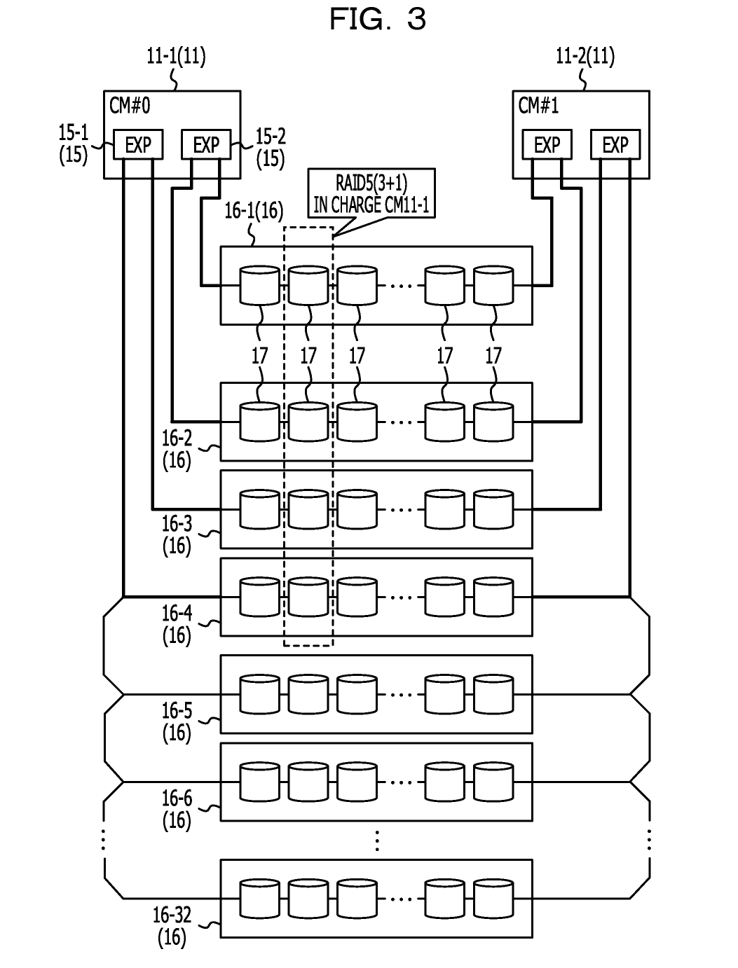

Next, the logical connection between the CMs 11 and the disks in the information processing system 1 illustrated in FIG. 1 will be described. FIG. 3 illustrates an example of the connection between the CMs 11 and storage devices 17 in the embodiment. The physical connection between the CMs 11 and the storage devices 17 differs depending on the types (low end, mid-range, high end) of devices used and an example for mid-range devices is illustrated in FIG. 3.

As illustrated in FIG. 3, each CM 11 is equipped with two IOCs (expanders) 15 and two SASs are wired to each IOC 15. In the example illustrated in FIG. 3, thirty-two DEs 16 (DE 16-1 to DE 16-32) are provided and each SAS is connected to a single DE 16. In order to retain redundancy, each CM 11 is connected to each DE 16.

That is, even if one of the CMs 11 breaks down, disks mounted in a DE 16 may be accessed from the other CM 11. During normal operation, SAS connection of a CM 11 (hereafter, referred to as an “in-charge CM”) that manages a RAID formed of a plurality of DEs 16 is used. The DEs 16-4 to 16-32, which are the fourth DE 16 onward from the side close to the CMs 11, are connected to each other so as to be linked together.

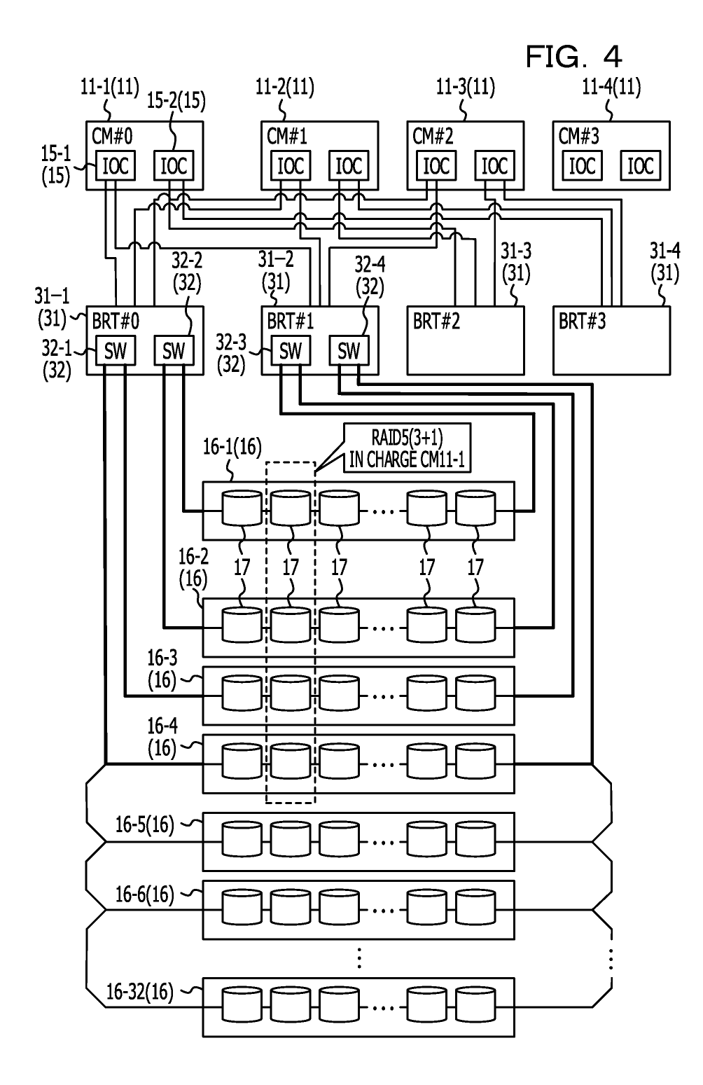

For example, a “RAID 5 (3+1)” is formed of four storage devices 17 enclosed by the broken line rectangle in FIG. 3 and in the case where the “RAID 5 (3+1)” is managed by the CM 11-1, which is the in-charge CM, SAS connections represented by the thick lines in FIG. 3 are used. FIG. 4 illustrates another example of the connection between the CMs 11 and disks in the embodiment. As illustrated in FIG. 4, in the case where there are four CMs 11, backend routers (BRTs) 31-1 to 31-4 are provided between the CMs 11 and the disks. The BRT 31-1 includes two switches 32-1 and 32-2 and two SASs are wired to each of the two switches 32-1 and 32-2. The BRT 31-2 includes two switches 32-3 and 32-4 and two SASs are wired to each of the two switches 32-3 and 32-4.

Also in the example of FIG. 4, thirty-two DEs 16 (DE 16-1 to DE 16-32) are provided and an SAS is connected to each of the BRTs 31-1 to 31-4 but in order to retain redundancy, each CM 11 is connected to each BRT. That is, even if one of the CMs 11 breaks down, disks mounted in a DE 16 may be accessed from another CM 11.

During normal operation, SAS connection of a CM 11 (“in-charge CM”) that manages a RAID formed of a plurality of DEs 16 is used. The DEs 16-4 to 16-32, which are the fourth DE 16 onward from the side close to the CMs 11, are connected to each other so as to be linked together. For example, a “RAID 5 (3+1)” is formed of four storage devices 17 enclosed by the broken line rectangle in FIG. 4 and in the case where the “RAID 5 (3+1)” is managed by the CM 11-1, which is the in-charge CM, SAS connections represented by the thick lines in FIG. 4 are used.

Operation

Next, the operation of the storage system 10 of the embodiment will be described.

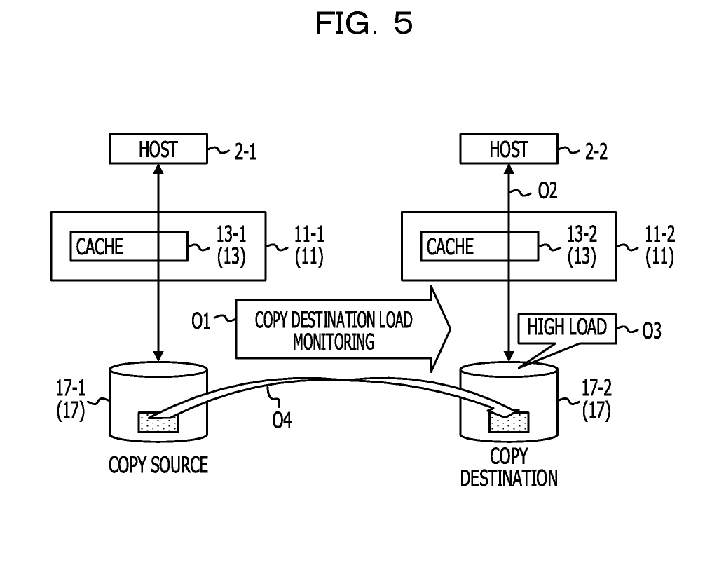

FIG. 5 illustrates operations of the CMs 11 in the embodiment. Hosts 2-1 and 2-2 and cache memories 13-1 and 13-2 in FIG. 5 have similar configurations and functions to the host 2 and cache memory 13 in FIG. 1, respectively. As illustrated in FIG. 5, in the storage system 10 of this embodiment, the monitoring unit 21 of the copy source in-charge CM 11-1 that is controlling copying continuously monitors amount (host I/O response time) of the host I/O load and the disk busy percentage of both the copy source storage device 17-1 and the copy destination storage device 17-2 (O1).

Here, I/O processing from the host 2-2 to the copy destination storage device 17-2 occurs (O2). Thus, the load of the copy destination storage device 17-2 increases (O3). At this time, the copy source transitioning unit 23 of the copy source CM 11-1 causes the mode of the copy source CM 11-1 and the copy destination CM 11-2 to transition in accordance with the monitored load values and thresholds thereof.

Then, the load adjusting unit 24 of the copy source CM 11-1 adjusts amount of the copy load for the copying from the copy source storage device 17-1 to the copy destination storage device 17-2 (O4). In addition to this, the copy source executing unit 25 of the copy source CM 11-1 and the copy destination executing unit 27 of the copy destination CM 11-2 change the priority of processing to execute host I/O processing with priority over other processing depending on a result of the mode transition.

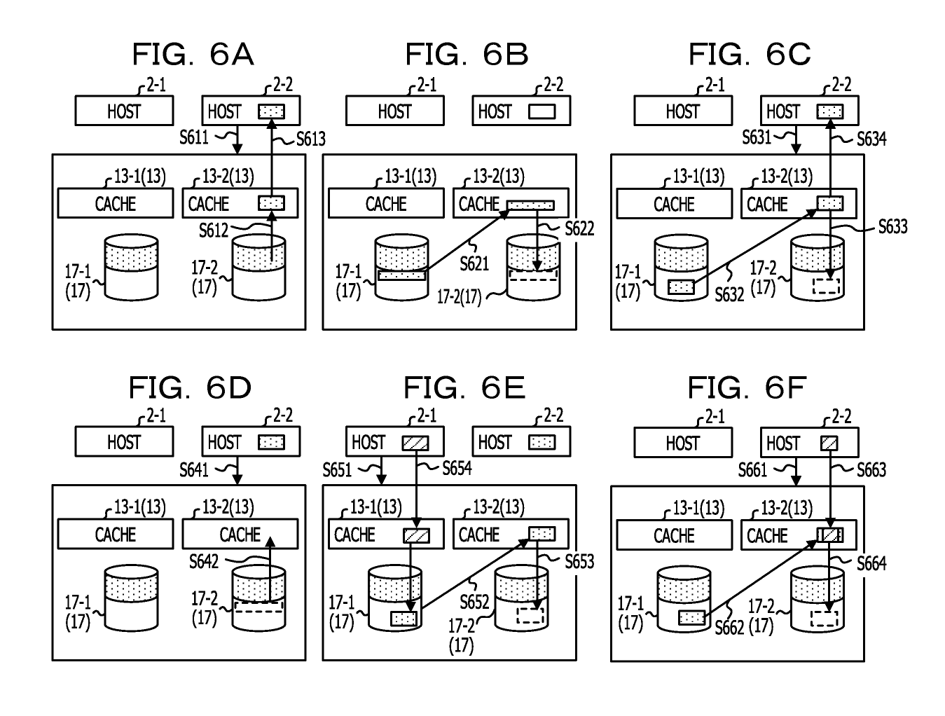

Here, in the information processing system 1 executing the operations illustrated in FIG. 5, examples of I/O to the copy destination storage device 17-2 during the copy processing include six patterns illustrated in FIGS. 6A to 6F. FIGS. 6A to 6F illustrate I/O patterns for the copy destination storage device 17-2 during copy processing in the embodiment. These I/O processing operations compete with each other and the I/O processing from the host 2 to the copy destination storage device 17-2 is delayed.

As illustrated in FIG. 6A, in the case where sequential Read I/O from the host 2-2 to the copy destination storage device 17-2 occurs (S611), data is transferred (staging) from the copy destination storage device 17-2 to the cache memory 13-2 (S612), and data is read out from the cache memory 13-2 into the host 2-2 (S613).

Alternatively, as illustrated in FIG. 6B, in the case of initial copy from the copy source storage device 17-1 to the copy destination storage device 17-2, data is transferred from the copy source storage device 17-1 to the cache memory 13-2 (S621) and then the data is written (write back) into the copy destination storage device 17-2 from the cache memory 13-2 (S622).

Alternatively, as illustrated in FIG. 6C, in the case where sequential Read I/O occurs from the copy destination host 2-2 to an area of the copy destination storage device 17-2 for which copying has not been completed (S631), data is transferred from the copy source storage device 17-1 to the cache memory 13-2 (S632). The data is written from the cache memory 13-2 into the copy destination storage device 17-2 (S633), and is read out from the cache memory 13-2 into the host 2-2 (S634).

Alternatively, as illustrated in FIG. 6D, in the case where sequential Read I/O from the copy destination host 2-2 to the copy destination storage device 17-2 occurs (S641), prefetching may be performed (S642). However, the prefetching is wasted.

Alternatively, as illustrated in FIG. 6E, in the case where Write I/O occurs from the copy source host 2-1 to an area of the copy source storage device 17-1 for which copying has not been completed (S651), data is transferred from the copy source storage device 17-1 to the cache memory 13-2 (S652), and the data is then written from the cache memory 13-2 into the copy destination storage device 17-2 (S653). Thereafter, the Write I/O is executed.

Alternatively, as illustrated in FIG. 6F, in the case where Write I/O occurs from the copy destination host 2-2 to an area of the copy destination storage device 17-2 for which copying has not been completed (S661), data is transferred from the copy source storage device 17-1 to the cache memory 13-2 (S662) and the data in the cache memory 13-2 is updated (S663). After that, the data is written from the cache memory 13-2 into the copy destination storage device 17-2 (S664).

Next, mode transitions (state transitions) of the CM 11 will be described. FIG. 7 illustrates state transitions of the CM 11 in the embodiment. As illustrated in FIG. 7, the CM 11 operates in one of the three modes of a normal mode (Mode_A), a response secured mode (Mode_B), and a copy destination preferred mode (Mode_C).

Normal Mode (Mode_A)

The normal mode is a mode in which amount of the copying (copy load) is adjusted in accordance with amount of the host I/O loads of the copy source storage device 17-1 and amount of the copy destination storage device 17-2. In this example, the host I/O response time will be used as an example of the amount of the host I/O load.

The monitoring unit 21 of the copy source CM 11-1 monitors amount of the host I/O load to the copy source CM 11-1 and in the case where the amount of the host I/O load reaches a predetermined threshold (for example 100 ms), the copy source executing unit 25 of the copy source CM 11-1 increases the copy execution interval and reduces amount of the copying in order to lighten the load.

Response Secured Mode (Mode_B)

In the response secured mode, for example, in the case where amount of host I/O load in the copy source or the copy destination continues to exceed a predetermined threshold (for example, 100 ms) for a certain period of time (for example, 60 s), or in the case where a state in which disk busy percentage in the copy source or the copy destination is equal to or more than a predetermined threshold (for example, 100%) has continued for a certain period of time (for example, 60 s), the I/O processing of the storage device that has reached the threshold is executed with priority over other processing. For example, in the case where the threshold has been reached in the copy destination storage device 17-2, I/O processing to the copy destination storage device 17-2 is executed with priority over other processing.

At this time, the priority of the I/O processing is changed in accordance with the combination of the copy source, copy destination and the access pattern. For example, in the case where sequential Read I/O to the copy destination storage device 17-2 occurs, if the state becomes the response secured mode in accordance with the amount of the host I/O load and the disk busy percentage, the copy source executing unit 25 of the copy source CM 11-1 suspends the initial copy.

Alternatively, in the case where the Read I/O that occurs is I/O to an area of the copy destination storage device 17-2 for which copying has not been completed, the copy source executing unit 25 reads out the corresponding data from the copy source storage device 17-1 without the load adjusting unit 24 of the copy source CM 11-1 performing the wasted prefetching (refer to FIG. 6D). In the case where sequential Write I/O to the copy destination storage device 17-2 occurs, as has been described above, the load adjusting unit 24 of the copy source CM 11-1 adjusts the multiplicity of the copy processing and reduces the disk busy percentage.

Alternatively, in the case where the Read I/O is local random access to the copy destination storage device 17-2, the copy source executing unit 25 of the copy source CM 11-1 suspends the initial copy. In addition, in order to improve the hit rate, the copy source executing unit 25 copies areas which are to be used in the random access to the copy destination storage device 17-2 with priority over others.

Copy Destination Preferred Mode (Mode_C)

In the copy destination preferred mode, for example, in the case where the host I/O response time of the copy destination has continued to exceed a predetermined threshold (for example, 100 ms) for a certain period of time (for example, 60 s), and the busy percentage of the copy destination storage device 17-2 also exceeds 100%, the I/O processing of the copy destination storage device 17-2 is executed with priority over other processing in order to lighten the I/O load.

In the copy destination preferred mode, a copy bitmap and a copy destination buffer, which are not illustrated, are used. I/O from the host to an area of the copy source storage device 17-1 for which copying has not been completed is made to stand by in accordance with the access frequency (disk busy percentage) and I/O processing to the copy destination storage device 17-2 is given the highest priority.

Access to Copy Destination Storage Device 17-2

For example, in the case where I/O processing to the copy destination storage device 17-2 occurs, the following patterns may be considered.

In the case where I/O processing occurs to an area of the copy destination storage device 17-2 for which copying has been completed, access is made to an area of the copy destination storage device 17-2 for which the copying has been completed. In the case where Read I/O is made to an area for which copying has not been completed, access is made to the copy source storage device 17-1. In this case, when a Write operation of writing data to the copy source storage device 17-1 is to be made to an area for which copying has not been completed, it is desirable to secure integrity of the data.

Accordingly, at the time of operation in the copy destination preferred mode, in the case where Read/Write I/O occurs from the host 2-1 to an area of the copy source storage device 17-1 for which copying has not been completed, integrity of the data is secured by temporarily moving the data to a hot spare area and performing difference management using a copy management table (not illustrated) in the cache memory 13. At the time operation in the copy destination preferred mode, in the case where Read/Write I/O occurs from the host 2-2 to an area of the copy destination storage device 17-2 for which copying has not been completed, host I/O to the copy destination storage device 17-2 is executed after the copy source executing unit 25 has executed copying of this area.

In addition, at the time of operation in the copy destination preferred mode, initial copy in which copying is executed in address order is suspended. In the case where the disk busy percentage of the copy destination storage device 17-2 has reached 100%, Write I/O to an area of the copy destination storage device 17-2 for which copying has not been completed is ended by updating the copy bitmap (not illustrated). The copy processing is restarted when the disk busy percentage of the copy destination storage device 17-2 falls below 100%.

Access to Copy Source Storage Device 17-1

In the case where I/O processing to the copy source storage device 17-1 occurs, the following patterns may be considered. In the case where I/O processing is made to an area of the copy source storage device 17-1 for which copying has been completed and Read I/O is made to an area of the copy source storage device 17-1 for which copying has not been completed, access is made to those areas of the copy source storage device 17-1.

In the case where the disk busy percentage has reached 100%, I/O processing is made to stand by and I/O processing is restarted when the disk busy percentage is dropped below 100%. In the case where Write I/O occurs to an area of the copy source storage device 17-1 for which copying has not been completed, data is copied to a buffer (for example, the cache memory 13) of the copy destination CM 11-2 and I/O processing is executed.

Also in this case, when the disk busy percentage has reached 100%, I/O processing is made to stand by. The I/O processing is restarted when the disk busy percentage falls.

Next, description will be given of state transitions between the three modes described above. The CM 11 transitions its state depending on two conditions (COND_1 and COND_2). COND_1 is that a state in which the host I/O response time is for example 100 ms or more has continued for example 60 s or more in the copy source or the copy destination. COND_2 is that a state in which the busy percentage of the copy destination is equal to or more than the busy percentage of the copy source and the busy percentage of the copy destination is equal to or more than 100% has continued for example 60 s or more. As indicated by arrow 102 of FIG. 7, in the state of the normal mode, when COND_1 is satisfied and COND_2 is not satisfied, the mode is shifted to the response secured mode.

Conversely, as indicated by arrow 101, in the state of the response secured mode, when COND_1 is not satisfied, the mode is returned to the normal mode.

In addition, as indicated by arrow 103, in the state of the response secured mode, when both COND_1 and COND_2 are satisfied, the mode is shifted to the copy destination preferred mode.

Conversely, as indicated by arrow 104, in the state of the copy destination preferred mode, when COND_1 is satisfied and COND_2 is not satisfied, the mode returns to the response secured mode.

In addition, as indicated by arrow 105, in the state of the copy destination preferred mode, when COND_1 is not satisfied the mode is shifted to the normal mode.

Conversely, as indicated by arrow 106, in the state of the normal mode, when both COND_1 and COND_2 are satisfied, the mode is shifted to the copy destination preferred mode.

The state transition processing is exemplified by the flowchart in FIG. 8. FIG. 8 illustrates a flowchart that exemplifies the state transition processing of the CMs 11 in this embodiment. When copying is started, in S1, the monitoring unit 21 of the copy source CM 11-1 monitors amounts (host I/O response times) of the host I/O loads of the copy source and the copy destination and the determining unit 22 determines whether any one of the state in which amount (host I/O response time) of the host I/O load of the copy source is equal to or more than 100 ms and the state in which amount (host I/O response time) of the host I/O load of the copy destination is equal to or more than 100 ms has continued for example 60 s or more.

In the case where it is determined in S1 that none of the state in which amount (host I/O response time) of the host I/O load of the copy source is equal to or more than 100 ms and the state in which amount (host I/O response time) of the host I/O load of the copy destination is equal to or more than 100 ms has continued for example 60 s or more (“<100 ms” in S1), the copy source transitioning unit 23 causes, in S2, the copy source CM 11-1 to transition to the normal mode and notifies the copy destination transitioning unit 26 of the copy destination CM 11-2 to transition to the normal mode. In the case where they are already in the normal mode, the transition is not performed.

In the case where it is determined in S1 that the state in which amount (host I/O response time) of the host I/O load is equal to or more than 100 ms has continued 60 s or more in the copy source or the copy destination (“≧100 ms” in S1), the monitoring unit 21 of the copy source CM 11-1 monitors, in S3, the disk busy percentages of the copy source and the copy destination and the determining unit 22 compares these percentages. In the case where it is determined in S3 that the state in which the disk busy percentage of the copy source is less than or equal to the disk busy percentage of the copy destination has not continued for 60 s or more (“source >destination” in S3), the copy source transitioning unit 23 causes, in S4, the copy source CM 11-1 and the copy destination CM 11-2 to transition to the response secured mode. In the case where they are already in the response secured mode, the transition is not performed.

In the case where it is determined in S3 that the state in which the disk busy percentage of the copy source is less than or equal to the disk busy percentage of the copy destination has continued for 60 s or more (“source destination” in S3), the monitoring unit 21 of the copy source CM 11-1 determines, in S5, whether the state in which the disk busy percentage of the copy destination has reached 100% has continued for 60 s or more. In the case where it is determined in S5 that the state in which the disk busy percentage of the copy destination has reached 100% has not continued for 60 s or more (“<100%” in S5), the copy source transitioning unit 23 causes, in S4, the copy source CM 11-1 and the copy destination CM 11-2 to transition to the response secured mode.

In the case where it is determined in S5 that the state in which the disk busy percentage of the copy destination has reached 100% has continued for 60 s or more (“≧100%” in S5), the copy source transitioning unit 23 causes, in S6, the copy source CM 11-1 and the copy destination CM 11-2 to transition to the copy destination preferred mode. In the case where they are already in the copy destination preferred mode, the transition is not performed.

Effect

Thus, according to this embodiment, I/O to/from a copy destination storage device may be performed regardless of the state of progress of copying, and I/O processing to/from the copy destination storage device may be efficiently performed during copy processing.

In addition, during copy processing, the occurrence of situations in which I/O to/from a copy source storage device is affected by I/O to/from the copy destination storage device is reduced. In addition, as a result of the mode of the CMs 11 being made to transition between three modes by using a threshold such as a load value, a user may set an appropriate threshold in accordance with the operation conditions of the system and flexibly adjust response time of the I/O processing during advanced copying.

In addition, in the copy destination storage device, delay of mount processing of Microsoft (Registered Trademark) Windows (Registered Trademark) may be prevented and a situation in which the host freezes may be avoided.

Other Considerations

Independent of the above-described embodiment, various modifications may be made within the gist of the embodiment.

For example, in the above-described embodiment, an example is described in which four CMs 11 are provided, but three or less CMs 11 or five or more CMs 11 may be provided. In the above-described embodiment, host I/O response time and disk busy percentage are used to indicate the load value, but another indicator that indicates the load value may be used. In the above-described embodiment, the load values of both the copy source and the copy destination are monitored but instead the load value of at least either one of the copy source and the copy destination may be monitored.

In the above-described embodiment, in the copy destination preferred mode, I/O processing is executed with priority over copy processing but in addition to or instead of changing the priority of processing in the copy destination preferred mode, the copy interval may be adjusted. In the above-described embodiment, the load value is monitored in units of storage devices 17, which are the SSD 17a and HDDs 17b, but monitoring of load value may instead be performed in units of a RAID. Therefore, the term “storage device 17” used in this specification includes a RAID formed of the SSD 17a and HDDs 17b in addition to the SSD 17a and the HDDs 17b.

In the above-described embodiment, the threshold of a load value is described by giving a specific value, but the threshold is not limited to the above-mentioned value and may be appropriately set. A program for realizing the functions of the monitoring unit 21, the determining unit 22, the copy source transitioning unit 23, the load adjusting unit 24, the copy source executing unit 25, the copy destination transitioning unit 26 and the copy destination executing unit 27 is supplied by being recorded on a recording medium that is capable of being read by a computer. Examples of the recording medium include a flexible disk, a compact disc (CD) including CD-ROM, CD-R, CD-RW or the like, a digital versatile disk (DVD) including DVD-ROM, DVD-RAM, DVD-R, DVD+R, DVD-RW, DVD+RW, HD DVD or the like, a BluRay disk, a magnetic disk, an optical disk or a magneto-optical disk. A computer reads out the program from the recording medium, transfers the program an internal storage device or an external storage device, and stores the program therein. The program may be recorded on a storage device (recording medium) such as a magnetic disk, an optical disk or a magneto-optical disk and supplied from the storage device to the computer via a communication line.

When realizing the functions of the monitoring unit 21, the determining unit 22, the copy source transitioning unit 23, the load adjusting unit 24 and the copy source executing unit 25 of the copy source CM 11-1, a program (storage control program) stored in an internal storage device (in this embodiment, a ROM or the like, which is not illustrated) is executed by a microprocessor (CPU 14 of the CM 11-1 in this embodiment) of the computer. At this time, the computer may read out and execute a program recorded on a recording medium.

When realizing the functions of the copy destination transitioning unit 26 and the copy destination executing unit 27 of the copy destination CM 11-2, a program (storage control program) stored in an internal storage device (in this embodiment, a ROM or the like, which is not illustrated) is executed by a microprocessor (CPU 14 of the CM 11-2 in this embodiment) of the computer. At this time, the computer may read out and execute a program recorded on a recording medium.

In this embodiment, the term “computer” expresses a concept including hardware and an operating system and means hardware that operates under the control of an operating system. In addition, in the case where an operating system is not needed and hardware is caused to operate independently of an application program, the hardware itself corresponds to a computer. The hardware includes at least a microprocessor such as a CPU and a device for reading out a computer program recorded on a recording medium, and in this embodiment the CMs 11 has the functions of a computer.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage control device comprising:
a processor to
monitor a load value of a first storage device or a second storage device during copy processing in which a copy of data stored in the first storage device is stored in the second storage device, and
control, in a case where the load value exceeds a predetermined threshold, the first storage device and the second storage device so that input/output processing to/from the second storage device is executed with priority over the copy processing.

2. The storage control device according to claim 1, wherein
the load value is amount of host input/output load of the first storage device or the second storage device, the host input/output load being a load that occurs when a host inputs or outputs data to or from a storage device.

3. The storage control device according to claim 1, wherein
the load value is usage percentage of the first storage device or the second storage device.

4. The storage control device according to claim 1, wherein
the processor executes the input/output processing with priority over the copy processing by performing the input/output processing while suspending the copy processing.

5. The storage control device according to claim 1, wherein
the processor lowers, in a case where the load value exceeds the predetermined threshold, frequency or multiplicity of the copy processing.

6. The storage control device according to claim 5, wherein
the processor operates, based on the load value, in any one of
a first mode in which the frequency or the multiplicity of the copy processing is lowered,
a second mode in which the frequency or the multiplicity of the copy processing is lowered and the input/output processing is executed with priority over the copy processing, and
a third mode in which the input/output processing is executed while suspending the copy processing.

7. A method for controlling storage devices, the method comprising:
monitoring, by a storage control device, a load value of a first storage device or a second storage device during copy processing in which a copy of data stored in the first storage device is stored in the second storage device; and
controlling, in a case where the load value exceeds a predetermined threshold, the first storage device and the second storage device so that input/output processing to/from the second storage device is executed with priority over the copy processing.

8. A computer-readable recording medium storing a program that causes a computer to execute a procedure, the procedure comprising:
monitoring a load value of a first storage device or a second storage device during copy processing in which a copy of data stored in the first storage device is stored in the second storage device; and
controlling, in a case where the load value exceeds a predetermined threshold, the first storage device and the second storage device so that input/output processing to/from the second storage device is executed with priority over the copy processing.
